(19) United States
(12) Patent Application Publication
(10) Pub. No.: US 2022/0297589 A1
(43) Pub. Date: Sep. 22, 2022

(54) EXPANDABLE ROOF SYSTEM

(71) Applicant: Michael CORDUFF, Great Bromley, Essex (GB)

(72) Inventor: Michael CORDUFF, Great Bromley, Essex (GB)

(21) Appl. No.: 17/631,909

(22) PCT Filed: Aug. 3, 2020
(86) PCT No.: PCT/EP2020/071838

§ 371 Date: Feb. 1, 2022

(30) Foreign Application Priority Data
Aug. 1, 2019 (GB) 1910994.1

(51) Int. Cl. B60P 3/34; E04B 1/343

(52) U.S. Cl. CPC B60P 3/34; E04B 1/34305

(57) ABSTRACT

An expandable roof system (100) for an expandable vehicle, trailer (200) or transportable unit, comprises a fixed roof component (10), a first moveable roof component (20) and a second moveable roof component (30). The first moveable roof component (20) is mounted above the fixed roof component (10), and the second moveable roof component (30) is mounted above both the fixed roof component (10) and the first moveable roof component (20). The first moveable roof component (20) is arranged for lateral movement between a stored position in which it overlies the fixed roof component (10) and a deployed position in which it is laterally offset from a first side (16) of the fixed roof component (10). The second moveable roof component (30) is arranged for lateral movement between a stored position in which it overlies both the fixed roof component (10) and the first moveable roof component (20), and a deployed position in which it is laterally offset from a second side (11) of the fixed roof component (10).

The present invention relates, in a first aspect thereof, to an expandable roof system for a vehicle, trailer or transportable unit. In a second aspect, the present invention further relates to an expandable vehicle, trailer or transportable unit having such an expandable roof system.

The present invention has been developed in particular with reference to expandable vehicles, trailers or transportable units, such as those used for transportable medical or hospitality facilities, outside broadcast units, and also in power generation and military applications. It is envisaged however that the invention may be utilised in a wide range of other vehicles, trailers or transportable units.

The term “transportable unit” as used herein refers to a facility adapted to be transported from one location to another on a low loader trailer, but which is independent of the trailer chassis, and is deployed to stand freely of the trailer chassis when in use.

Commercial vehicles, trailers and transportable units are typically manufactured to have the maximum overall dimensions permitted when being moved on the road. This in-transit width is limited in most countries to about 2.5 m. Some vehicles, trailers and transportable units can be expanded to provide more space inside when stationary. This is of particular relevance in relation to vehicles, trailers and transportable units used as medical or hospitality facilities, and the like. However, such vehicles, trailers and transportable units are often still fairly narrow when expanded and there is a need to be able easily to expand to greater widths. The known systems also often require a long time and rather complex mechanisms to expand and retract.

The present invention seeks to provide an improved expandable roof system for an expandable vehicle, trailer or transportable unit.

According to a first aspect of the present invention, there is provided an expandable roof system for a vehicle, trailer or transportable unit, the system comprising:
a fixed roof component, adapted to be mounted on a vehicle, trailer or transportable unit, and having opposed first and second sides;
a first moveable roof component, mounted above the fixed roof component and arranged for lateral movement between a stored position wherein said first moveable roof component overlies the fixed roof component, and a deployed position wherein said first moveable roof component is laterally offset from the first side of the fixed roof component; and
a second moveable roof component, mounted above the fixed roof component and the first moveable roof component, and arranged for lateral movement between a stored position wherein said second moveable roof component overlies the fixed roof component and a second deployed position wherein said second moveable roof component is laterally offset from the second side of the fixed roof component.

As will be appreciated from the above, when in their deployed positions, the first and second moveable roof components are offset from opposite sides of the fixed roof component. The expandable roof system therefore covers a substantially larger area when the first and second moveable roof components are in their deployed positions relative to when said components are in their stored positions.

When the moveable roof components are in their stored positions, the second moveable roof component is preferably supported by the first moveable roof component and the fixed roof component. The first moveable roof component is in turn preferably supported by the fixed roof component.

When the moveable roof components are in their deployed positions, the first and second moveable roof components are preferably supported by the fixed roof component.

The fixed roof component preferably comprises a first abutment at or adjacent the first side thereof, and a second abutment at or adjacent the second side thereof. The first abutment is configured to limit the range of movement of the first moveable roof component; and the second abutment is configured to limit the range of movement of both the first and second moveable roof components.

The second abutment preferably comprises a roller or slider to facilitate the movement of the second moveable roof component over the fixed roof component and the first moveable roof component.

In a preferred embodiment, the first moveable roof component has a free first edge having a bracket connected at or adjacent thereto, and an opposed second edge adapted for connection to a moveable side wall of a vehicle, trailer or transportable unit. When the first moveable roof component is in its stored position, the bracket preferably abuts against the second abutment thereby to limit the range of movement of the first moveable roof component. When the first moveable roof component is in its deployed position, the bracket preferably connects to the first abutment, thereby to support the first moveable roof component, and further provides a seal between the first moveable roof component and the fixed roof component.

The free first edge of the first moveable roof component preferably further comprises a roller or slider mounted at or adjacent thereto and configured to facilitate the movement of the first moveable roof component over the fixed roof component.

In a preferred embodiment, the second moveable roof component also has a free first edge having a bracket connected at or adjacent thereto, and an opposed second edge adapted for connection to a moveable side wall of vehicle trailer, or transportable unit. When the second moveable roof component is in its deployed position, the bracket connects to the second abutment, thereby to support the second moveable roof component, and further provides a seal between the second moveable roof component and the fixed roof component.

The seals provided between the roof components are preferably substantially fluid-tight seals.

The free first edge of the second moveable roof component preferably further comprises a roller or slider mounted at or adjacent thereto and configured to facilitate the movement of the second moveable roof component over the first moveable roof component.

The rollers or sliders may take the form of any suitable sliding and/or rolling means, including low friction blocks. The rollers or sliders may in some embodiments be mounted in or on rails that are provided on the roof components.

In preferred embodiments, the width of the first and second moveable roof components substantially corresponds to the width of the fixed roof component, such that the overall width of the expandable roof system when the moveable roof components are in their deployed positions is at least 2.5 times, and preferably substantially 3 times, greater than the overall width of the expandable roof system when the moveable roof components are in their stored positions.

According to a second aspect of the present invention, there is provided an expandable vehicle, trailer or transportable unit comprising an expandable roof system as hereinbefore described with reference to the first aspect of the present invention.

The expandable vehicle, trailer or transportable unit according to the second aspect of the present invention is adapted for selective conversion between a compact configuration wherein the first and second moveable roof components are each arranged in their stored positions, and an expanded configuration wherein the first and second moveable roof components are each arranged in their deployed positions.

In preferred embodiments of the vehicle, trailer or transportable unit, the second edge of the first moveable roof component is connected to a first moveable side wall, and the second edge of the second moveable roof component is connected to a second moveable side wall, said first and second moveable side walls each being supported on slidable base members mounted on the vehicle, trailer or transportable unit.

In preferred embodiments, the width of the fixed roof component substantially corresponds to the width of the vehicle, trailer or transportable unit, such that the overall width of the vehicle, trailer or transportable unit in its expanded configuration is at least 2.5 times, and preferably substantially three times, greater than the overall width of the vehicle, trailer or transportable unit in its compact configuration.

In use, when converting the vehicle, trailer or transportable unit from the compact configuration to the expanded configuration, the free first edge of the second moveable roof component moves across, and is supported by, the first moveable roof component. As the second moveable roof component reaches its deployed position, said free first edge engages with, and is supported by the second abutment. The free first edge of the first moveable roof component then moves across, and is supported by the fixed roof component. As the first moveable roof component reaches its deployed position, said free first edge engages with, and is supported by, the second abutment.

In use, when converting the vehicle, trailer or transportable unit from the expanded configuration to the compact configuration, the free first edge of the first moveable roof component moves across, and is supported by, the fixed roof component, until abutting the second abutment upon reaching its stored position. The second moveable roof component then moves across the first moveable roof component to reach its stored position overlying the first moveable roof component and the fixed roof component.

The expandable roof system according to the first aspect of the present invention is suitable for use in expandable vehicles, trailers or transportable units according to the second aspect of present invention which may include lorries, lorry trailers, caravans, campervans, exhibition trailers, exhibition units, mobile photographic units, medical wards, waiting rooms, medical theatres, transportable medical facility units, transportable hospitality facilities, outside broadcast units, transportable power generation units, transportable units for military applications, or any transportable facility where a large open unrestricted space is required.

As will be appreciated, the expandable roof system and expandable vehicle, trailer or transportable unit of the present invention allow an expanded space to be deployed quickly and without requiring complex mechanisms. The overall width of the roof and vehicle, trailer or transportable unit, and thus the total expanded space available, can be much greater than would be possible using a conventional expansion system, allowing a greater variety of uses. The expandable roof system enables the overall width of the vehicle, trailer or transportable unit in its expanded configuration to be substantially three times greater than its width in the compact configuration. Taking into account the maximum in-transit widths allowed for vehicles or trailers, in most countries the maximum expanded width would equate to approximately 7.4 m, with a clear span.

The provision of a double overlapping roof arrangement as hereinbefore described also allows the first and second moveable roof components to be higher than the fixed roof component, thus maintaining the internal ceiling height when the vehicle, trailer or transportable unit is in the expanded configuration. In addition, the way the roof components overlap and are supported on one another as they expand allows for substantially fluid-tight sealing between the components in both compact and expanded configurations.

By way of example only, preferred embodiments of the invention will now be described in detail with reference being made to the accompanying drawings in which:

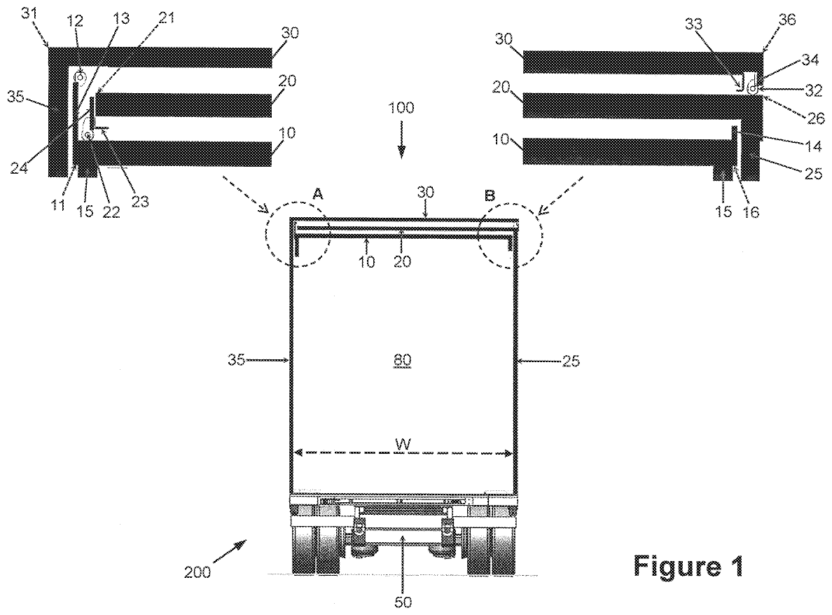

FIG. 1 shows a cross-sectional end view and enlarged detail views A and B of an expandable roof system and expandable vehicle trailer according to preferred embodiments of the present invention, shown in a compact configuration;

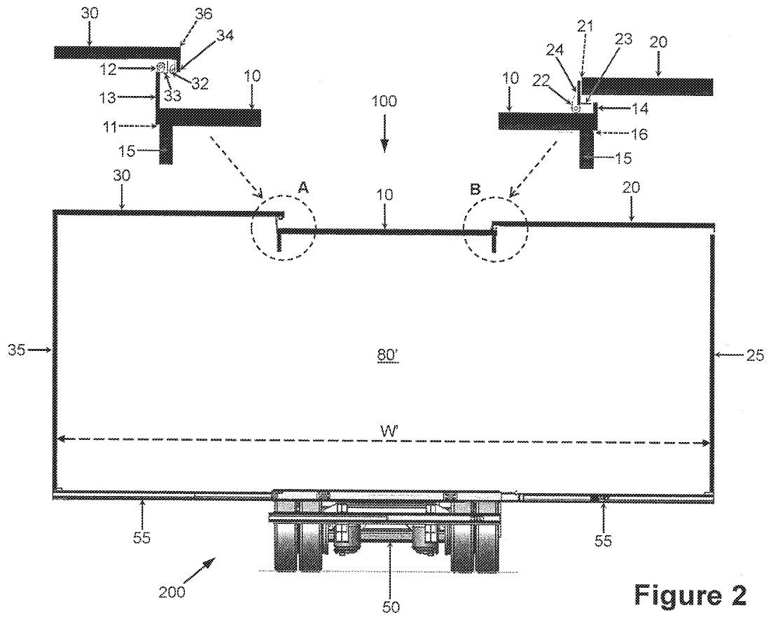

FIG. 2 shows a cross-sectional end view and enlarged detail views A and B of the expandable roof system and expandable vehicle trailer of FIG. 1, shown in an expanded configuration; and

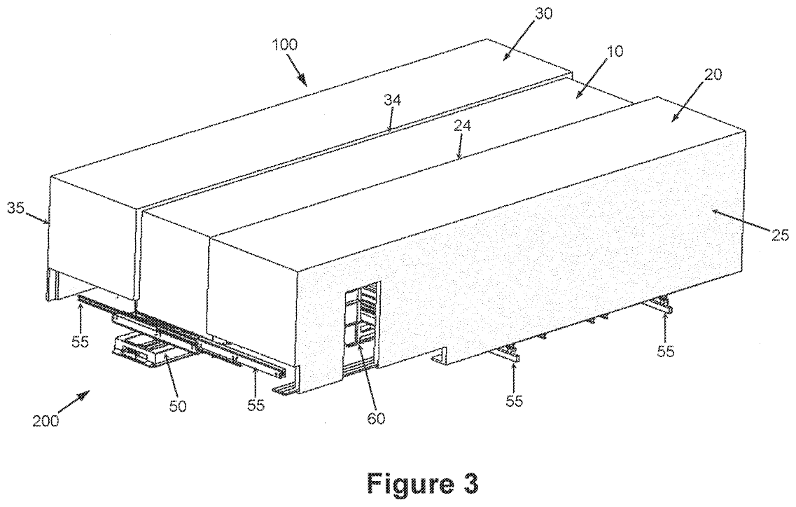

FIG. 3 shows a perspective view of the expandable vehicle trailer of FIG. 2, shown in its expanded configuration.

FIGS. 1 to 3 show an expandable roof system 100 according to a first aspect of the present invention, fitted to an expandable vehicle trailer 200, according to a second aspect of the present invention. The expandable roof system 100 comprises a fixed roof component 10, a first moveable roof component 20, and a second moveable roof component 30.

FIG. 1 shows the expandable roof system 100 with the first and second moveable roof components 20, 30 in their stored positions, and consequently the trailer 200 in its compact configuration. The second moveable roof component 30 is supported by the first moveable roof component 20 and the fixed roof component 10, and the first moveable roof component 20 is in turn supported by the fixed roof component 10.

FIGS. 2 and 3 show the expandable roof system 100 with the first 20 and second 30 moveable roof components in their deployed positions, and consequently the trailer 200 in its expanded configuration. The second moveable roof component 30 is now supported by the fixed roof component 10 but not by the first moveable roof component 20; whilst the first moveable roof component 20 remains supported by the fixed roof component 10.

Referring to FIG. 1, the fixed roof component 10 is mounted on posts 15 which in turn are mounted on the chassis 50 of the trailer 200. The first and second moveable roof components 20, 30 in their stored positions above the fixed roof component 10 span substantially the entire width ‘W’ of the trailer 200 in the compact configuration, e.g. when the trailer 200 is moving or not in use.

The fixed roof component 10 has a first side 16 and a second side 11. A first abutment 14 upstands at the first side 16 of the fixed roof component 10, and a second abutment 13 upstands at the second side 11. The height of the second abutment 13 is greater than the height of the first abutment 14 such that the second abutment 13 extends from the fixed roof component 10 above the first moveable roof component 20. The first abutment 14 extends from the fixed roof component 10 to below the first moveable roof component 20. The first abutment 14 and second abutment 13 limit the extent to which the first moveable roof component 20 can move laterally across the fixed roof component 10. A roller or slider 12 is also secured on the second abutment 13, to facilitate rolling or sliding the second moveable roof component 30 laterally over the fixed roof component 10 and the first moveable roof component 20.

The first moveable roof component 20 has a free first edge 21 and a second edge 26. A bracket 24 is connected at or adjacent to free first edge 21, and a first moveable side wall 25 is connected to second edge 26. A roller or slider 22 is secured to bracket 24 to facilitate rolling or sliding the first moveable roof component 20 laterally over the fixed roof component 10. Bracket 24 comprises a ledge 23 which extends inwardly away from roller or slider 22, as shown in FIG. 1 (enlarged detail ‘A’).

The second moveable roof component 30 also has a free first edge 36 and a second edge 31. A second moveable side wall 35 is connected to second edge 31. A plate 34 is attached at first free edge 36 and extends downwardly towards second edge 26 of the first moveable roof structure 20 as shown in FIG. 1 (enlarged detail ‘B’). A roller or slider 32 is secured to the plate 34 to facilitate rolling or sliding the second moveable roof component 30 over the first moveable roof component 20. The plate 34 and roller or slider 32 are together configured to provide a seal between the first and second moveable roof components 20,30. A bracket 33 is provided on the underside of the second moveable roof component 30 at an inset position from free first edge 36 as shown in FIG. 1 (enlarged detail ‘B’).

In the compact configuration shown in FIG. 1, the first moveable side wall 25 abuts the first abutment 14 of the fixed roof component 10 and the second moveable side wall 35 abuts the second abutment 13 of the fixed roof component 10.

When extending from the compact configuration (FIG. 1) to the expanded configuration (FIGS. 2 and 3), the second moveable roof component 30 moves first. The first free edge 36 of the second moveable roof component 30 is supported by the first moveable roof component 20 via roller or slider 32 as the second moveable roof component 30 moves over the first moveable roof component 20. As the second moveable roof component 30 reaches its deployed position, as shown in FIG. 2 (expanded detail ‘A’), free first end 36 engages with, and is supported by, the second abutment 13 via roller or slider 12 and bracket 33. Bracket 33 and second abutment 13 together provide a substantially fluid-tight seal between the fixed roof component 10 and the second moveable roof component 30.

The first moveable roof component 20 then moves in the opposite direction across the fixed roof component 10, supported via roller or slider 22. As the first moveable roof component 20 reaches its deployed position, as shown in FIG. 2 (expanded detail ‘B’), the ledge 23 engages with, and is supported by the first abutment 14. The ledge 23 and first abutment 14 together provide a substantially fluid-tight seal between the fixed roof component 10 and the first moveable roof component 20.

The second moveable side wall 35 and first moveable side wall 25 are supported on slidable base members 55 mounted to the chassis 50 as shown in FIGS. 2 and 3. The base members 55 may be expandable, although foldable or collapsible arrangements may also be utilised.

The first and second side walls 25, 35 together with the fixed roof component 10 and the first and second moveable roof components 20, 30, define a compact space 80 within the trailer 200 when in its compact configuration as shown in FIG. 1, and an expanded space 80′ within the trailer 200 when in its expanded configuration as shown in FIG. 2. The side walls 25, 35 may comprise a structural framework to which metal panels or plastic sheets or tarps may be secured. An entrance 60 may also be provided in the side walls 25, 35 as shown in FIG. 3.

1. An expandable roof system for a vehicle, trailer or transportable unit, the system comprising:
a fixed roof component, adapted to be mounted on a vehicle, trailer or transportable unit, and having opposed first and second sides;
a first moveable roof component, mounted above the fixed roof component and arranged for lateral movement between a stored position wherein said first moveable roof component overlies the fixed roof component, and a deployed position wherein said first moveable roof component is laterally offset from the first side of the fixed roof component; and
a second moveable roof component, mounted above the fixed roof component and the first moveable roof component, and arranged for lateral movement between a stored position wherein said second moveable roof component overlies the fixed roof component and a second deployed position wherein said second moveable roof component is laterally offset from the second side of the fixed roof component.

2. An expandable roof system as claimed in claim 1, wherein:
when the first and second moveable roof components are in their stored positions, the second moveable roof component is supported by the first moveable roof component and the fixed roof component, and the first moveable roof component is in turn supported by the fixed roof component; and
when the first and second moveable roof components are in their deployed positions, the first and second moveable roof components are supported by the fixed roof component.

3. An expandable roof system as claimed in claim 2, wherein the fixed roof component comprises a first abutment at or adjacent the first side thereof, and a second abutment at or adjacent the second side thereof, wherein the first abutment is configured to limit the range of movement of the first moveable roof component, and the second abutment is configured to limit the range of movement of both the first and second moveable roof components.

4. An expandable roof system as claimed in claim 3, wherein the second abutment is provided with a roller or slider configured to facilitate the movement of the second moveable roof component over the fixed roof component and the first moveable roof component.

5. An expandable roof system as claimed in claim 3, wherein the first moveable roof component has a free first edge having a bracket connected at or adjacent thereto, and an opposed second edge adapted for connection to a moveable side wall of a vehicle, trailer or transportable unit, wherein:
when the first moveable roof component is in its stored position, said bracket abuts against the second abutment thereby to limit the range of movement of the first moveable roof component, and
when the first moveable roof component is in its deployed position, said bracket connects to the first abutment, thereby to support the first moveable roof component, and further providing a seal between the first moveable roof component and the fixed roof component.

6. An expandable roof system as claimed in claim 5, wherein the free first edge of the first moveable roof component further comprises a roller or slider mounted at or adjacent thereto and configured to facilitate the movement of the first moveable roof component over the fixed roof component.

7. An expandable roof system as claimed in claim 3, wherein the second moveable roof component has a free first edge having a bracket connected at or adjacent thereto, and an opposed second edge adapted for connection to a moveable side wall of a vehicle, trailer or transportable unit,
wherein when the second moveable roof component is in its deployed position, said bracket connects to the second abutment, thereby to support the second moveable roof component, and further providing a seal between the second moveable roof component and the fixed roof component.

8. An expandable roof system as claimed in claim 7, wherein the free first edge of the second moveable roof component further comprises a roller or slider mounted at or adjacent thereto and configured to facilitate the movement of the second moveable roof component over the first moveable roof component.

9. An expandable roof system as claimed in claim 1, wherein the width of the first and second moveable roof components substantially corresponds to the width of the fixed roof component, such that the overall width of the expandable roof system when the first and second moveable roof components are in their deployed positions is substantially three times greater than the overall width of the expandable roof system when the first and second moveable roof components are in their stored positions.

10. An expandable vehicle, trailer or transportable unit comprising an expandable roof system as claimed in claim 1, said vehicle, trailer or transportable unit being adapted for selective conversion between a compact configuration wherein the first and second moveable roof components are each arranged in their stored positions, and an expanded configuration wherein the first and second moveable roof components are each arranged in their deployed positions.

11. An expandable vehicle, trailer or transportable unit, said vehicle, trailer or transportable unit being adapted for selective conversion between a compact configuration wherein the first and second moveable roof components are each arranged in their stored positions, and an expanded configuration wherein the first and second moveable roof components are each arranged in their deployed positions and comprising an expandable roof system as claimed in claim 7, wherein the second edge of the first moveable roof component is connected to a first moveable side wall, and the second edge of the second moveable roof component is connected to a second moveable side wall, said first and second moveable side walls each being supported on slidable base members mounted on the vehicle, trailer or transportable unit.

12. An expandable vehicle, trailer or transportable unit, said vehicle, trailer or transportable unit being adapted for selective conversion between a compact configuration wherein the first and second moveable roof components are each arranged in their stored positions, and an expanded configuration wherein the first and second moveable roof components are each arranged in their deployed positions and comprising an expandable roof system as claimed in claim 9, wherein the width of the fixed roof component substantially corresponds to the width of the vehicle, trailer or transportable unit, such that the overall width of the vehicle, trailer or transportable unit in its expanded configuration is substantially three times greater than the overall width of the vehicle, trailer or transportable unit in its compact configuration.

13. An expandable vehicle, trailer or transportable unit said vehicle, trailer or transportable unit being adapted for selective conversion between a compact configuration wherein the first and second moveable roof components are each arranged in their stored positions, and an expanded configuration wherein the first and second moveable roof components are each arranged in their deployed positions and comprising an expandable roof system as claimed in claim 8, wherein the second edge of the first moveable roof component is connected to a first moveable side wall, and the second edge of the second moveable roof component is connected to a second moveable side wall, said first and second moveable side walls each being supported on slidable base members mounted on the vehicle, trailer or transportable unit.

14. An expandable roof system as claimed in claim 4, wherein the first moveable roof component has a free first edge having a bracket connected at or adjacent thereto, and an opposed second edge adapted for connection to a moveable side wall of a vehicle, trailer or transportable unit,
wherein:
when the first moveable roof component is in its stored position, said bracket abuts against the second abutment thereby to limit the range of movement of the first moveable roof component, and
when the first moveable roof component is in its deployed position, said bracket connects to the first abutment, thereby to support the first moveable roof component, and further providing a seal between the first moveable roof component and the fixed roof component.
